(19) United States
(12) Patent Application Publication
(10) Pub. No.: US 2008/0082706 A1
(43) Pub. Date: Apr. 3, 2008

(54) METHODS, SYSTEMS, AND COMPUTER PRODUCTS FOR SCSI POWER CONTROL, DATA FLOW AND ADDRESSING

(75) Inventors: Patrick A. Buckland, Austin, TX (US); Philip M. Corcoran, Highland, NY (US); Edward J. Seminaro, Milton, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/536,745

(22) Filed: Sep. 29, 2006

(51) Int. Cl. G06F 13/00

(52) U.S. Cl. 710/104

(57) ABSTRACT

Methods, systems and computer products for SCSI power control, data flow and addressing. Exemplary embodiments include a SCSI system having a SCSI bus with a plurality of data lines, including a first repeater configuration, a second repeater configuration, a method for selectively enabling at least one of the first and second repeater configurations and a method for selectively assigning SCSI IDs on devices on a SCSI bus.

### BACKGROUND

The present disclosure relates generally to small computer system interface (SCSI), and in particular, to an automatic method and system for controlling power, data flow and device addressing in a SCSI disk drawer with two daisy chained SCSI buses and dual initiators.

Parallel SCSI disk drives and other SCSI device parallel configurations having dual initiators and daisy-chained buses can often be difficult to address and manage. For example, in a parallel SCSI disk drive configuration daisy chaining two six drive buses with dual initiators can require the manual setting of jumpers or dip switches to properly address the disks on the bus without causing SCSI ID conflicts that can cause misaddressing and data flow problems. The manual setting is necessary for both enabling repeaters on the bus as well as to control data flow.

It is therefore apparent that an automatic system for an automatic system as described.

### BRIEF SUMMARY

Embodiments of the invention include a SCSI system having a SCSI bus with a plurality of data lines, the system including a first repeater configuration, a second repeater configuration, means for selectively enabling at least one of the first and second repeater configurations and means for selectively assigning SCSI IDs on devices on a SCSI bus.

Additional embodiments include a method in a SCSI system having daisy chained SCSI buses, including providing term power from at least one of a first and second repeater configuration in response to receiving term power, selectively enabling repeaters disposed on the first and second repeater configurations and in response to being term power enabled, causing one of the repeaters on the first and second repeater configurations to shift SCSI IDs on a daisy chained SCSI bus, the daisy chained SCSI bus being coupled to the first and second repeater configurations.

Further embodiments include a method for controlling power, data flow and SCSI addressing on a SCSI bus, the method icluding providing a dual initiated daisy chained and cross-linked SCSI bus having multiple SCSI devices on the SCSI bus, wherein the SCSI bus comprises dedicated enabling lines, sensing the presence of at least one of repeater cards and host systems coupled to the SCSI bus, enabling a repeater on repeater cards and shifting SCSI IDs on devices coupled to the SCSI bus in response to sensing the presence of at least one of repeater cards and host systems coupled to the SCSI bus.

Other sytems, methods, and/or computer program products according to embodiments will be or become apparents to one with skill in the art upon review of the following drawings and detailed description. It is intended that all such additional systems, methods, and/or computer program products be included within this description, be within the scope of the present invention, and be protected by the accompanying claims

### BRIEF DESCRIPTION OF THE DRAWINGS

The subject matter which is regarded as the invention is particularly pointed out and distictly claimed in the claims at the conclusion of the specification. The foregoing and other objects, features, and advantages of the invention are apparent from the following detailed description taken in conjunction with the accompanying drawings in which:

FIG. 1 illustrates a block diagram of an exemplary embodiment of a SCSI controller system;

FIG. 2 illustrates a block diagram of an exemplary embodiment of a SCSI drawer coupled to a SCSI controller system;

FIG. 3 illustrates a block diagram of an exemplary embodiment of a SCSI controller system;

FIG. 4 illustrates a block diagram of an exemplary embodiment of a SCSI controller system;

FIG. 5 illustrates a block diagram of an exemplary embodiment of a SCSI controller system; and

FIG. 6 illustrates a block diagram of an exemplary embodiment of a SCSI controller system.

The detailed description explains the preferred embodiments of the invention, together with advantages and features, by way of example with reference to the drawings.

### DETAILED DESCRIPTION

In general, in exemplary embodiments, SCSI cables are coupled to SCSI adapters without the use of jumpers or dip-switches, to support multiple different configurations. Power control, data flow and drive addressing are automatically controlled and detected. Multiple combinations and configurations are possible with one or two adapters to each repeater card. Multiple repeater cards can further be daisy-chained to allow more drivers on the SCSI bus to the adapter. A given drive drawer can be powered on if any of the adapters are powered on and providing term power, which is provided by the adapter cards or any of the SCSI devices.

As discussed further in the description below, unused or reserved pins of a SCSI cable can be implemented to detect that two repeaters have been daisy chained Configuration is accomplished by comparing voltage levels on the unused or reserved pins, which are connected to a daisy-chained card or SCSI initiator port. In addition, the pins can be used to provide support so that so long as one or more adapters are powered on, the two daisy-chain repeaters remain turned on. Therefore, adapters may be powered on or off in any order. Furthermore, adapters that are powered off also have their repeaters turned off to allow concurrent maintenance of those adapters and repeaters.

It is therefore appreciated that each repeater in a SCSI drawer may be turned on or off by a SCSI adapter providing term power or by detecting that the repeater is tied to another repeater in a daisy chain configuration. If the daisy chain configuration is detected, one of the drive bays shifts it's SCSI IDs to avoid SCSI ID conflicts.

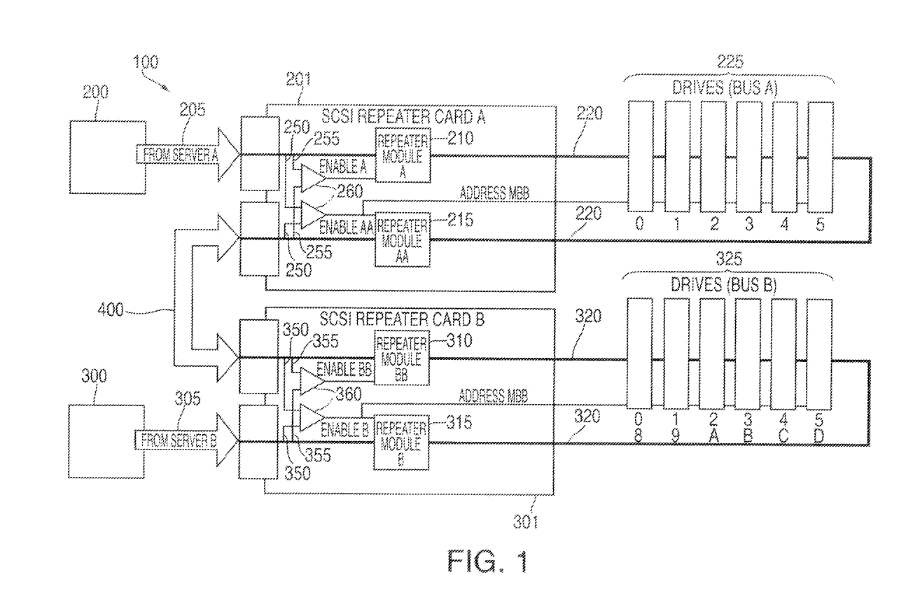

FIG. 1 illustrates a block diagram of an exemplary embodiment of a SCSI controller system 100. A first host device 200 and a second host device 300 are each coupled to a respective SCSI bus 205, 305, respectively. It is therefore appreciated that host devices 200, 300 operate as dial initiators for system 100, each host device 200, 300 being capable of requesting an I/O process on another SCSI device. Multiple target devices (not shown) may be present within SCSI bus 205 and SCSI bus 305. As is well known to those having ordinary skill in the art, the extension of a SCSI bus beyond a particular length requires the utilization of a repeater to prevent signals from weakening and to prevent noise. A repeater picks up the signal from the host adapter and reproduces the same signal on the next section of cable, thereby producing an enhanced signal for devices further down the bus or buses.

An extended SCSI bus 220 is coupled to repeater modules 210, 215. Extended SCSI bus 220 is coupled to target devices 225. Similarly, an extended SCSI bus 320 is coupled to repeater modules 310, 315. Extended SCSI bus 320 is coupled to target devices 325. While a plurality of hard disk drives are schematically depicted in FIG. 1, those skilled in the art appreciate that SCSI target devices 225, 325 may include any device capable of being utilized within a SCSI bus including, for example, tape backups, digital audio tape devices, optical drives, CD-ROM drives, printers, scanners, hard disk drives (HDD), etc. It is appreciated that a multi-bit SCSI ID is associated with each SCSI target device 225, 325. In one implementation, parallel SCSI disk drives and daisy-chained six-drive busses with dual initiators (as discussed) are used to control power, data flow and addressing as necessary. As discussed further in the description below, the above-described features are automatically performed without the need to manually set jumpers and dip switches.

In one implementation, SCSI bus includes a multi-pin cable as understood by one skilled in the art can include 68 pins as in the case of a SCSI B cable, for example. Several pins remain unused. In exemplary embodiments, two unused pins can be implemented for automatic control as discussed. For example, pins 19 and 53 can be used. However, it is understood that other unused or modified pins can be used in other exemplary embodiments. For example, reserved pins 53 and 19 may be used.

By connecting two of the unused pins and corresponding wires from the SCSI bus, and monitoring the term power signals, automatic detection of the presence of additional repeater cards on the bus can be detected. Referring still to FIG. 1, SCSI lines 250, 255 on SCSI device 201 and SCSI lines 350, 355 on SCSI device 301 can be input into comparators 260, 360 respectively. Comparators 260, 360 can be used to sense the voltages on the lines 250, 255, 350, 355 can an output can be generated. The outputs of the comparators 260, 360 can therefore be used to enable all repeater modules 210, 215, 310, 315 and to output a most signification bit (MSB) address to shift the SCSI IDs of target devices 225, 325.

Therefore, in exemplary embodiments, as discussed further in the description below, each set of SCSI devices 225, 325, which have their unique SCSI IDs, can have their IDs automatically shifted depending whether or not the devices 225, 325 are in use. For example, devices 225, 325 can have SCSI IDs 0, 1, 2, 3, 5 when in use individually. However, if devices 225, 325 are in use together, devices 325 can have their IDs automatically shifted to 8, 9, A, B, C, D. It is therefore appreciated SCSI target device 325 may be selectively cross linked to SCSI bus 220 for access by first host device 200 by automatically altering the SCSI ID of those devices such that no duplicate SCSI IDs are present within the combined bus.

Two unused wires on existing SCSI cables can be used in conjunction with SCSI repeater card circuits that sense if they are connected to another SCSI repeater card or host system. The circuits sense which ports are connected to servers that are powered on and enable the appropriate repeater modules. The SCSI repeater cards sense the voltages on the two wires to determine if they are the first or second card in a daisy chained SCSI bus. The card also senses which position it is in the disk drawer to set the repeater enable bits and addresses. The following is a truth table showing the card power status and enable bits for the repeater modules (see FIG. 1) for given configurations.

TABLE 1

| | Power A | Power B | EnA | EnAA | EnB | EnBB |
|---|---|---|---|---|---|---|
| Servers Off | Off | Off | X | X | X | X |
| | On | On | H | H | L | H |
| | On | On | L | H | H | H |
| | On | On | H | H | H | H |

Similarly when a single initiator card is cabled to a dual initiator card, the drive addresses are switched from 5, 4, 3, 2, 1, 0 to D, C, B, A, 9, 8 for some configurations in the disk drawer, as described further below. The following Figures illustrate exemplary embodiments of SCSI drawer applications.

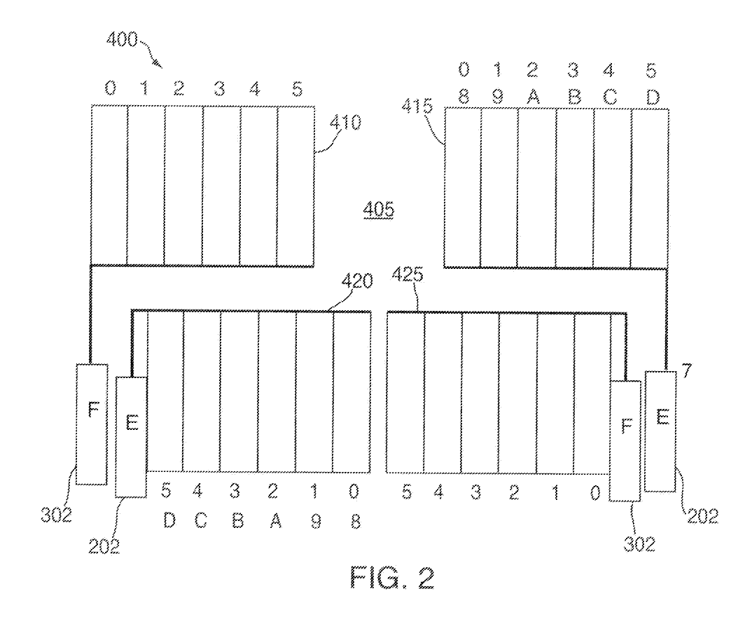

FIG. 2 illustrates a block diagram of an exemplary embodiment of a SCSI drawer coupled to a SCSI controller system 400. As illustrated, two sets are positioned in the front of the drawer and two sets are positioned in the rear. System 400 includes a drive drawer 405 made up with 4 sets of drives 410, 415, 420, 425. SCSI redriver cards 202, 302 can represent top and bottom redriver cards of system 400. Each SCSI redriver card 202, 303 can further have SCSI enclosure services (SES) having unique SCSI IDs. As further discussed above, SCSI IDs can be appropriately shifted depending on whether or not a single or dual port repeater is used.

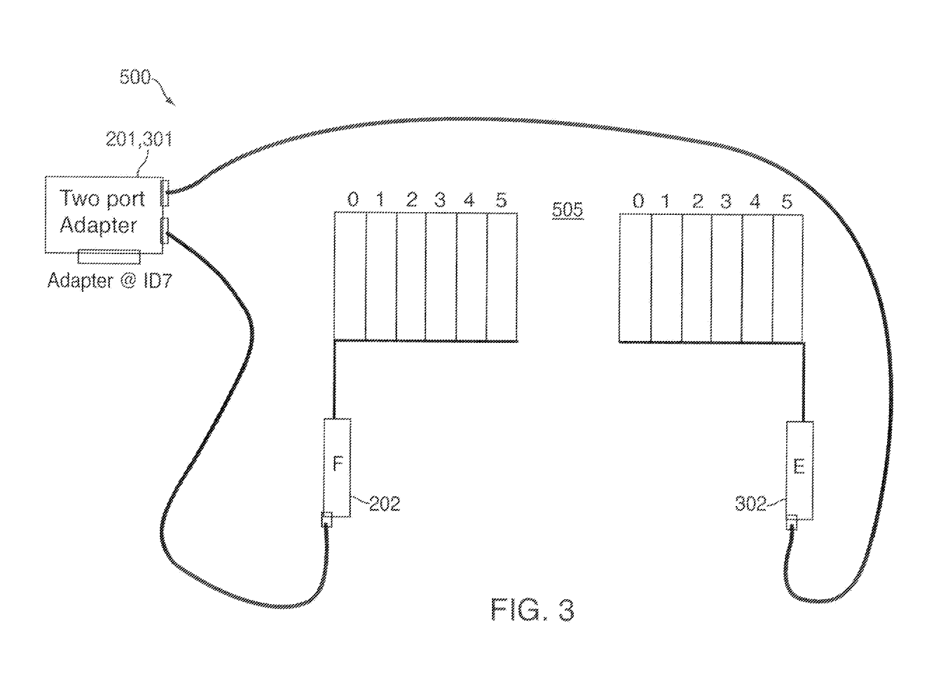

FIG. 3 illustrates a block diagram of an exemplary embodiment of a SCSI controller system 500. System 500 illustrates 12 drives to a single adapter card 201, 301, which can have SCSI ID 7. Only one half of system 500 is displayed for illustrative purposes. Two single port adapters could be implemented with two SCSI buses to 12 drives. Multiple SCSI cables are coupled to a single SCSI adapter 201, 301. Therefore, the configuration supports a single adapter card 201, 301 to two halves of redriver cards 202, 302 in drawer 505. As such, there can be straight power on and off with adapter term power. Both halves, that is, redriver card 202 and redriver card 302 each see term power.

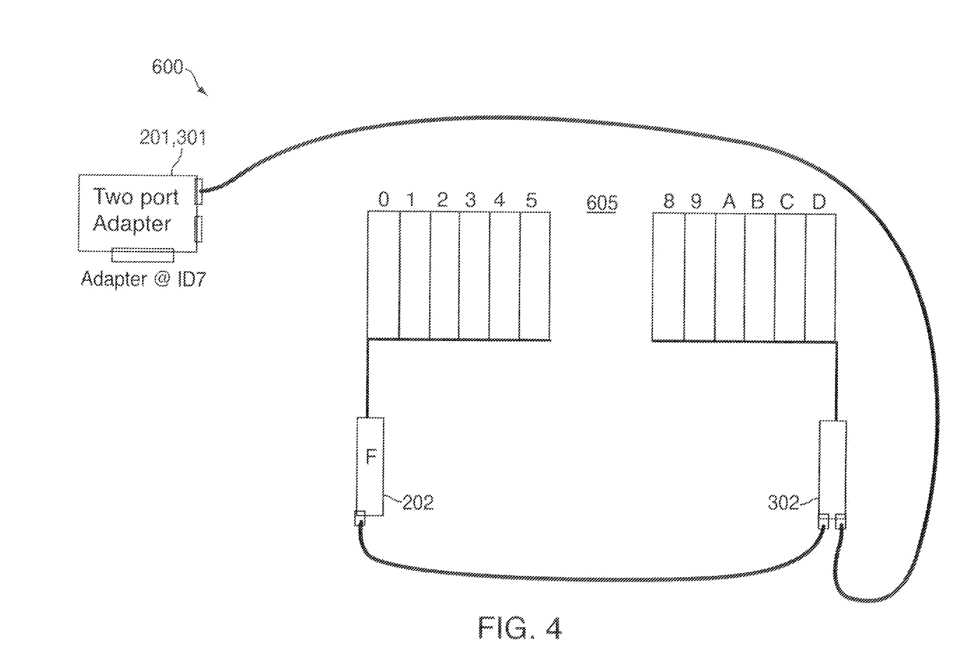

FIG. 4 illustrates a block diagram of an exemplary embodiment of a SCSI controller system 600. System 600 illustrates daisy chaining of two of the six drive packs for a total of 12 drives on one SCSI bus. In general, a single port expander is coupled to a dual port expander in drawer 605. Term power controls drawer 605 power on and off. The dual repeater on redriver 302 shifts the SCSI IDs as discussed. In general, to support the daisy chain configuration, redriver 302 includes a dual repeater. In one implementation, redriver 202 also includes a dual repeater. In another implementation, redriver 202 can include a single repeater. In general, the logic detects that there are two sets of six drives and that they are daisy chained. The appropriate repeaters are therefore enabled as discussed above.

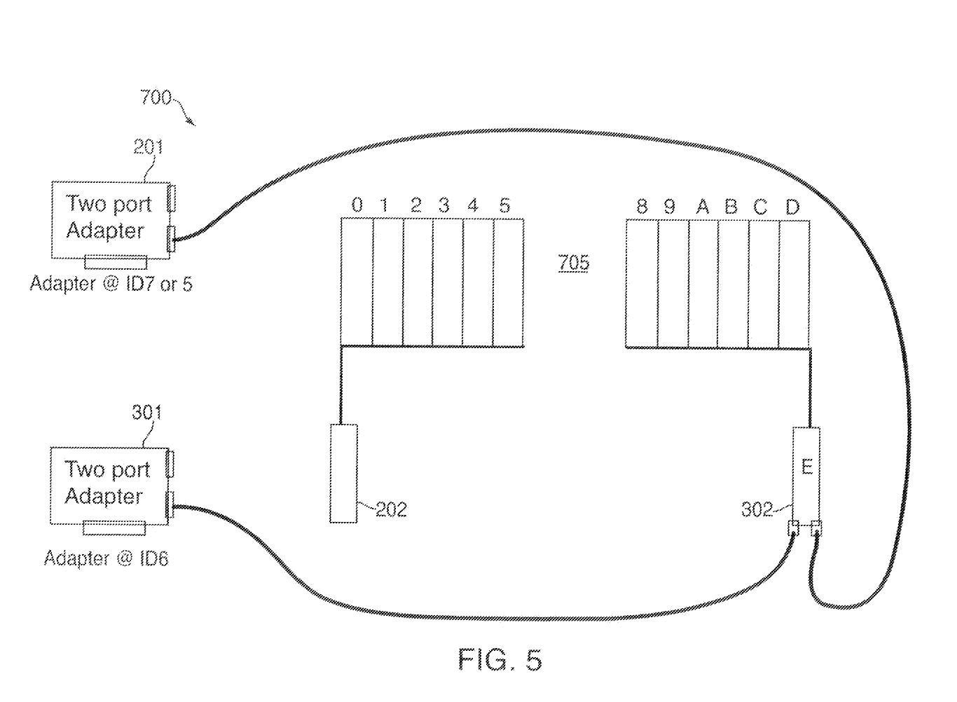

FIG. 5 illustrates a block diagram of an exemplary embodiment of a SCSI controller system 700. Although the SCSI ID can vary, in general, adapter card 201 can have SCSI ID 7 or 5 and adapter card 301 can have SCSI ID 6. System 700 illustrates dual initiators via SCSI devices 201, 301, further showing two adapters to one six drive pack. Each port of the repeater (redriver 302) is to a separate adapter. Either adapter 201, 301 can turn on the drawer 705. However, each adapter 201, 301 turns on its repeater in a dual repeater card. Each adapter 201, 301 provides straight power on and off with term power to each repeater on redrivers 202, 302.

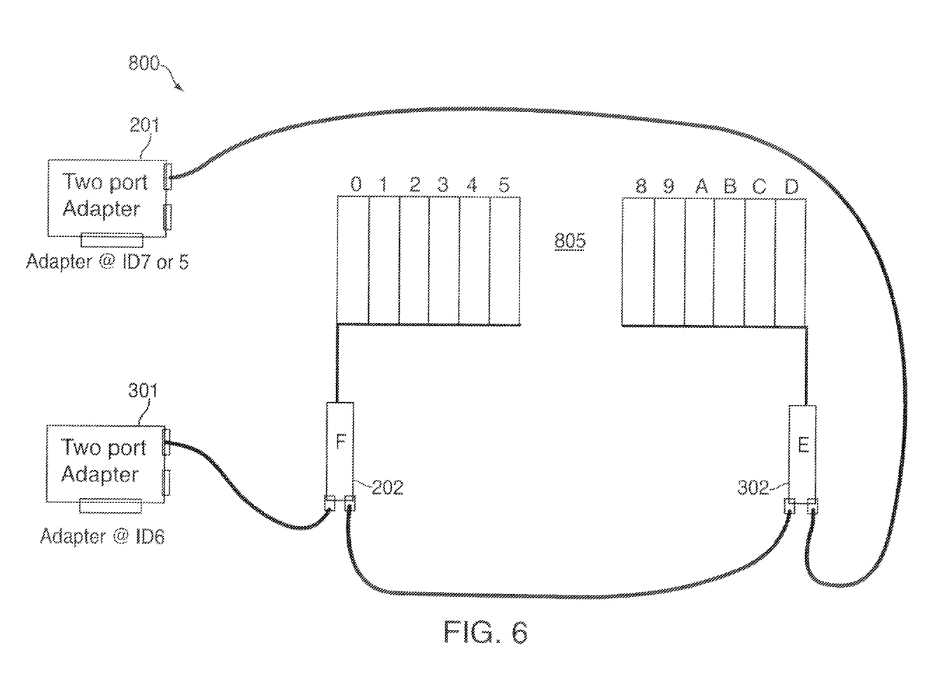

FIG. 6 illustrates a block diagram of an exemplary embodiment of a SCSI controller system 800. Although the SCSI ID can vary, in general, adapter card 201 can have SCSI ID 7 or 5 and adapter card 301 can have SCSI ID 6. System 800 illustrates dual initiators via adapter cards 201, 301, suporting 24 drives, that is two adapter cards to 12 drives. The dual repeater on redriver 302 shifts the SCSI IDs as discussed above. In general, both redriver cards include dual repeaters. If one repeater is powered on then the adapter repeater plus two daisy chains are powered on. If both repeaters are powered on, then all four repeaters power on. If both SCSI initiators power off, then all repeaters power off.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an etc. do not denote a limitation of quantity, but rather denote the presence of at least one of the referenced item.

What is claimed is:

1. A SCSI system having a SCSI bus with a plurality of data lines, the system comprising:
a first repeater configuration;
a second repeater configuration;
means for selectively enabling at least one of the first and second repeater configurations; and
means for selectively assigning SCSI IDs on devices on a SCSI bus.

2. The system as claimed in claim 1 wherein the first repeater configuration comprises dual repeaters.

3. The system as claimed in claim 1 wherein the second repeater configuration comprises dual repeaters.

4. The system as claimed in claim 1 wherein a first data line comprises a signal for automatically sensing the presence of multiple SCSI devices on the SCSI bus.

5. The system as claimed in claim 4 wherein a second data line comprises a signal for automatically sensing the presence of multiple SCSI devices on the SCSI bus.

6. The system as claimed in claim 5 wherein the first and second data lines selectively enable repeaters disposed on the first and second repeater configurations.

7. The system as claimed in claim 6 wherein SCSI IDs associated with devices on the SCSI bus are selectively and automatically configured in response to enabling SCSI devices in addition to SCSI devices previously disposed on the SCSI bus.

8. The system as claimed in claim 7 wherein the each of the first and second repeater configuration comprises a SCSI bus.

9. The system as claimed in claim 8 wherein the first and second repeater configurations each comprise an initiator.

10. The system as claimed in claim 9 wherein the SCSI system is cross-linked and dual initiated.

11. In a SCSI system having daisy chained SCSI buses, a method comprising:
providing term power form at least one of a first and second repeater configuration;
in response to receiving term power, selectively enabling repeaters disposed on the first and second repeater configurations; and
in response to being term power enabled, causing one of the repeaters on the first and second repeater configurations to shift SCSI IDs on a daisy chained SCSI bus, the daisy chained SCSI bus being coupled to the first and second repeater configurations.

12. The method as claimed in claim 11 further comprising providing term power from one of the repeater configurations.

13. The method as claimed in claim 12 wherein receiving term power from one of the repeater configurations enables a repeater on the one of the repeater configurations.

14. The method as claimed in claim 13 further comprising removing power from the one of the repeater configurations, thereby removing power from the SCSI bus.

15. The method as claimed in claim 11 further comprising providing term power from both of the repeater configurations.

16. The method as claimed in claim 11 further comprising removing power from both of the repeater configurations thereby removing power from the SCSI bus.

17. A method for controlling power, data flow and SCSI addressing on a SCSI bus, the method comprising:
providing a dual initiated daisy chained and cross-linked SCSI bus having multiple SCSI devices on the SCSI bus, wherein the SCSI bus comprises dedicated enabling lines;
sensing the presence of at least one of repeater cards and host systems coupled to the SCSI bus;
enabling a repeater on repeater cards; and
shifting SCSI IDs on devices coupled to the SCSI bus in response to sensing the presence of at least one of repeater cards and host systems coupled to the SCSI bus.

18. The method as claimed in claim 17 wherein sensing the presence of at least one of repeater cards and host systems comprises receiving signals provided on the dedicated enabling lines and in response to receiving the signals, enabling a repeater.

19. The method as claimed in claim 17 wherein shifting SCSI IDs on devices coupled to the SCSI bus in response to sensing the presence of at least one of repeater cards and host systems coupled to the SCSI bus comprises shifting SCSI IDs on devices coupled to the SCSI bus in response to the sensing of the presence of more that one source of term power.

20. The method as claimed in claim 17 further comprising providing power and addressing to the SCSI bus after making a determination of the number of repeaters present on the SCSI bus.
